(19) United States
(12) Patent Application Publication
(10) Pub. No.: US 2006/0112540 A1
(43) Pub. Date: Jun. 1, 2006

(54) Corrugated fin feeding apparatus and feeding method

(76) Inventors: Kenji Tochigi, Tokyo (JP); Kimio Nozaki, Tokyo (JP); Akira Yoshikawa, Tokyo (JP); Hirokazu Yaezawa, Tokyo (JP); Yasuyuki Shinohara, Tokyo (JP)

Correspondence Address: FOLEY AND LARDNER LLP;SUITE 500, 3000 K STREET NW, WASHINGTON, DC, 20007, US

(21) Appl. No.: 10/550,613

(22) PCT Filed: Mar. 19, 2004
(86) PCT No.: PCT/JP04/03805

§ 371 Date: Dec. 14, 2005

(30) Foreign Application Priority Data
Mar. 24, 2003 (JP) 2003-080617

(51) Int. Cl. B23P 15/26; B23P 19/00

(52) U.S. Cl. 29/726; 29/791; 29/795; 29/890.046

(57) ABSTRACT

The corrugated fin feeding apparatus has cutting devices (1) producing corrugated (C1, C2) fins with a predetermined length and a conveying device (2) determining positions of the corrugated fins and conveying them at predetermined intervals. Further, the feeding apparatus has a forcible conveying device (3) which adds a driving force to the corrugated fins being conveyed by the conveying device (4) to push out them toward the downstream side thereof and distributes them in predetermined directions, and an accumulating device which accommodates the corrugated fins into a plurality of accumulating rooms respectively. Furthermore, the feeding apparatus has an inserting device (5) which feeds a predetermined number of the corrugated fins simultaneously into a temporary assembling device (6) of a heat exchanger core when the predetermined number of them are accommodated into the accumulating rooms, and a control device (7) which synchronously controls the respective devices (8) based on the positions of the corrugated fins determined by the conveying device.

### FIELD OF THE INVENTION

The present invention relates to a corrugated fin feeding apparatus and a corrugated fin feeding method for feeding corrugated fins to a temporary assembling device of a heat exchanger core which alternately arranges tubes and corrugated fin.

### BACKGROUND OF THE PRESENT INVENTION

Conventional corrugated fin feeding apparatus are disclosed in Japanese Patent Application Laid-open No. Tokkaihei 3-166023 and Japanese Patent Application Laid-open No. Tokkaihei 9-085541.

In the conventional corrugated fin feeding apparatus, a corrugated fin material is conveyed by a pair of worms, and the number of ridges formed on the conveyed fin material is counted by a rotation counter utilizing the number of rotations of these worms. When the number of ridges reaches a predetermined value, the fin material is stopped and then a cutting blade is actuated to cut the fin material to produce a corrugated fin having a predetermined length, and the thus produced corrugated fin is then conveyed again and fed to a temporary assembling device of a heat exchanger core.

However, since the above described conventional corrugated fin feeding apparatuses repeatedly continue to cut the fin material by the cutting blade while stopping the fin material by the worms and then convey to feed the cut fin material by the worms, there have been problems such that not only the speed of production decreases but also a pitch skipping or a hitting dent of the corrugated fin occurs, so that the productivity of the heat exchanger core is largely decreased. These problems become notable especially when making the corrugated fin thinner, which has been an obstruction for making the corrugated fin lighter by reducing a thickness thereof.

Further, in order to separate the adjacent corrugated fins which are cut away from each other by the cutting blade of the conventional corrugated fin feeding apparatus, a separating device using air jet or the like should be used, which causes a problem of complicating control of the device.

The present invention is made in view of the above described problems, and an object thereof is to provide a corrugated fin feeding apparatus and a corrugated fin feeding method which can decrease a pitch skipping and a hitting dent of corrugated fins caused by cutting of a fin material being conveyed and are capable of separating the corrugated fins easily and inexpensively compared to the above conventional devices, thereby improving the productivity of the corrugated fins.

### SUMMARY OF THE INVENTION

A corrugated fin feeding apparatus of the present invention for feeding corrugated fins to a temporary assembling device of a heat exchanger core which alternately arranges tubes and corrugated fins for a heat exchanger to temporarily assemble the heat exchanger core includes: a cutting device which cuts a continuous fin material in corrugated form without stopping conveyance of the fin material toward a downstream side thereof to thereby produce corrugated fins having a predetermined length; and a conveying device which adds a force to the corrugated fins being cut to increase a speed thereof to separate the adjacent corrugated fins from each other to thereby convey the corrugated fins at predetermined intervals.

According to this corrugated fin feeding apparatus, the cutting device cuts the continuous fin material in corrugated form without stopping conveyance of the fin material toward the downstream side thereof to produce corrugated fins having a predetermined length.

Therefore, movement and stop of the fin material are not necessarily performed before and after the cutting operation of the cutting device as required in conventional inventions, so that a fin pitch skipping or a hitting dent on the corrugated fin does not occur.

Further, the conveying device adds the force to the corrugated fins being cut to increase the speed thereof to separate the corrugated fins to thereby convey the corrugated fins at predetermined intervals, so that the corrugated fins after being cut by the cutting device can be separated to be conveyed at predetermined intervals without using a complicated control or device as compared to conventional ones.

Preferably, the corrugated fin feeding apparatus further includes: a forcible conveying device which adds a driving force to the corrugated fins being conveyed to push out the corrugated fins toward a downstream side thereof and distributes the corrugated fins in predetermined directions; an accumulating device having a plurality of accumulating rooms into which the corrugated fins are distributed and accommodated respectively; an inserting device which feeds a predetermined number of the corrugated fins simultaneously to the temporary assembling device of the heat exchanger core when the predetermined number of the corrugated fins are accommodated into the accumulating rooms; and a control device which synchronously controls the forcible conveying device, the accumulating device, and the inserting device based on positions of the corrugated fins determined by the conveying device.

According to this corrugated fin feeding apparatus, the forcible conveying device adds the driving force to the corrugated fins to push the corrugated fins toward the downstream side thereof and distributes the corrugated fins in predetermined directions.

Further, when the accumulating device accommodates the predetermined number of the corrugated fins into the plural accumulating rooms, the inserting device feeds the predetermined number of corrugated fins to the temporary assembling device of the heat exchanger core.

In these cases, the control device controls operation of the forcible conveying device, the accumulating device, and the inserting device based on positions of the corrugated fins determined by the conveying device.

Therefore, by actuating the forcible conveying device, the accumulating device, and the inserting device while positions of the corrugated fins being cut by a predetermined length are detected by the control device, the processing of the corrugated fins by each device can be surely and easily performed.

Further, when the accumulating device accommodates the corrugated fins into the plural accumulating rooms, the inserting device simultaneously feeds the predetermined number of the corrugated fins to the temporary assembling device of the heat exchanger core, so that a plurality of the corrugated fins can be quickly fed to the temporary assembling device of the heat exchanger core without high costs as compared to conventional inventions, which contributes to increase productivity of the heat exchanger core.

Preferably, the conveying device includes: a belt conveyor which has a belt to convey the corrugated fins; and position determining portions provided at predetermined intervals on the belt of the belt conveyor, in which the corrugated fins are arranged between the position determining portions to determine positions of the corrugated fins to thereby convey the corrugated fins at predetermined intervals.

Therefore, the conveying device conveys the corrugated fins in a state that the corrugated fins are arranged between the position determining portions, so that the positions of the corrugated fins can be surely determined by a simple configuration to thereby convey the corrugated fins toward the downstream side thereof.

Preferably, the accumulating device includes: a rotating shaft; and a plurality of the accumulating rooms provided in parallel to an axial direction of the rotating shaft, in which the corrugated fins are accommodated while the plural accumulating rooms are rotated in a circumferential direction of the rotating shaft, and the inserting device feeds after the rotation thereof the corrugated fins to the temporary assembling device of the heat exchanger core.

Therefore, the accumulating device accommodates the corrugated fins while rotating the plural accumulating rooms in the circumferential direction of the rotating shaft, and the inserting device feeds after the rotation thereof the corrugated fins to the temporary assembling device of the heat exchanger core, so that the operation of accommodating the corrugated fins into the accumulating device and the operation of feeding the plural corrugated fins by the inserting device to the temporary assembling device of the heat exchanger core can be performed simultaneously.

Further, a corrugated fin feeding method of the present invention for feeding corrugated fins to a temporary assembling device of a heat exchanger core which alternately arranges tubes and corrugated fins to temporarily assemble the heat exchanger core includes: a cutting step of cutting a continuous fin material in corrugated form without stopping conveyance of the fin material toward a conveying direction thereof to thereby produce corrugated fins having a predetermined length; and a conveying step of adding a force to the corrugated fins being cut to increase a speed thereof to separate the adjacent corrugated fins from each other, determining front and rear positions of the corrugated fins, and conveying the corrugated fins.

Therefore, in the cutting step according to this method, the continuous fin material in corrugated form can be cut without stopping conveyance of the fin material to thereby produce corrugated fins having a predetermined length.

Then, in the conveying step, the force is added to the corrugated fins being cut to increase the speed thereof to separate the corrugated fins from each other, the front and rear positions of the separated corrugated fins are determined, and the corrugated fins are conveyed at predetermined intervals.

Therefore, as compared to conventional inventions, the corrugated fins after being cut can be separated to be conveyed at predetermined intervals without using a complicated control or device.

Preferably, the above-described corrugated fin feeding method further includes: a forcibly conveying step of adding a driving force to the corrugated fins being conveyed to push out the corrugated fins toward a downstream side thereof and distributing the corrugated fins in predetermined directions; an accumulating step of accommodating the corrugated fins being distributed into a plurality of accumulating rooms; and an inserting step of feeding the corrugated fins to the temporary assembling device of the heat exchanger core when a predetermined number of the corrugated fins is accumulated into the accumulating rooms.

Therefore, in the forcible conveying step, the driving force is added to the corrugated fins to push out the corrugated fins toward the downstream side thereof, and the corrugated fins are distributed in the predetermined directions.

Further, when the predetermined number of the corrugated fins are accommodated into the accumulating rooms in the accumulating step, the predetermined number of the corrugated fins are fed to the temporary assembling device of the heat exchanger core in the inserting step.

Thus, in the forcible conveying step, the driving force is added to the corrugated fins to push them out toward the downstream side thereof, and the corrugated fins are distributed in the predetermined directions; in the accumulating step, a predetermined number of the corrugated fins being conveyed are accommodated; and in the inserting step, the predetermined number of the corrugated fins are fed to the temporary assembling device of the heat exchanger core. Therefore, through the sequence of these steps, the predetermined number of the corrugated fins can be quickly and surely fed to the temporary assembling device of the heat exchanger core simultaneously.

### BRIEF DESCRIPTION OF THE DRAWINGS

FIG. 1 is a schematic side view of a corrugated fin feeding apparatus of an embodiment according to the present invention;

FIG. 2 is an enlarged plan view of a conveyor, a forcible conveying device, an accumulating case, and a temporary assembling device of a heat exchanger core shown in FIG. 1;

FIG. 3 is a plan view of a running cutting device shown in FIG. 1;

FIG. 4 is a side view of the running cutting device shown in FIG. 3;

FIG. 5 is a perspective view of the conveyor shown in FIG. 1;

FIG. 6 is a perspective view of the forcible conveying device shown in FIG. 1;

FIG. 7 is a perspective view of the accumulating case shown in FIG. 1;

FIG. 8A is a view showing a state before cutting a fin material by the running cutting device;

FIG. 8B is a view showing a state of determining a cutting position of the fin material by the running cutting device; and

FIG. 8C is a view showing a state of cutting the fin material by the running cutting device.

### DESCRIPTION OF THE PREFERRED EMBODIMENT

Hereinafter, a corrugated fin feeding apparatus of an embodiment according to the present invention will be described with reference to drawings.

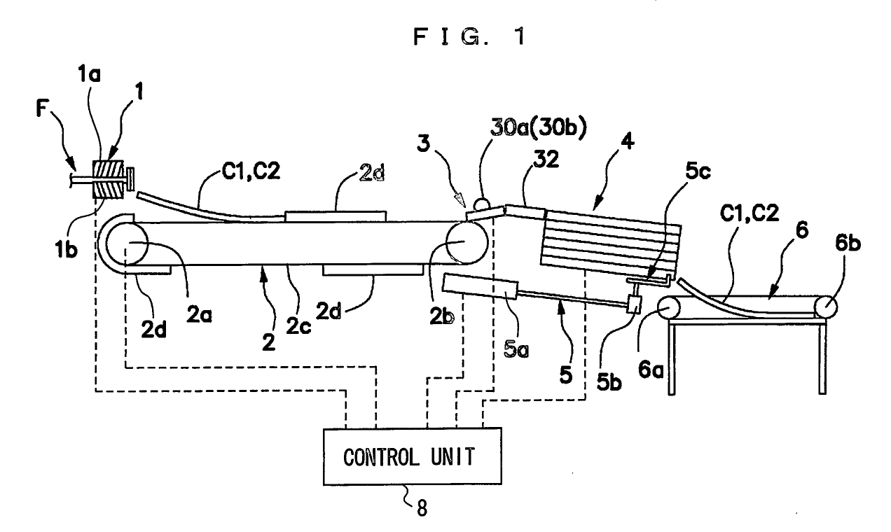

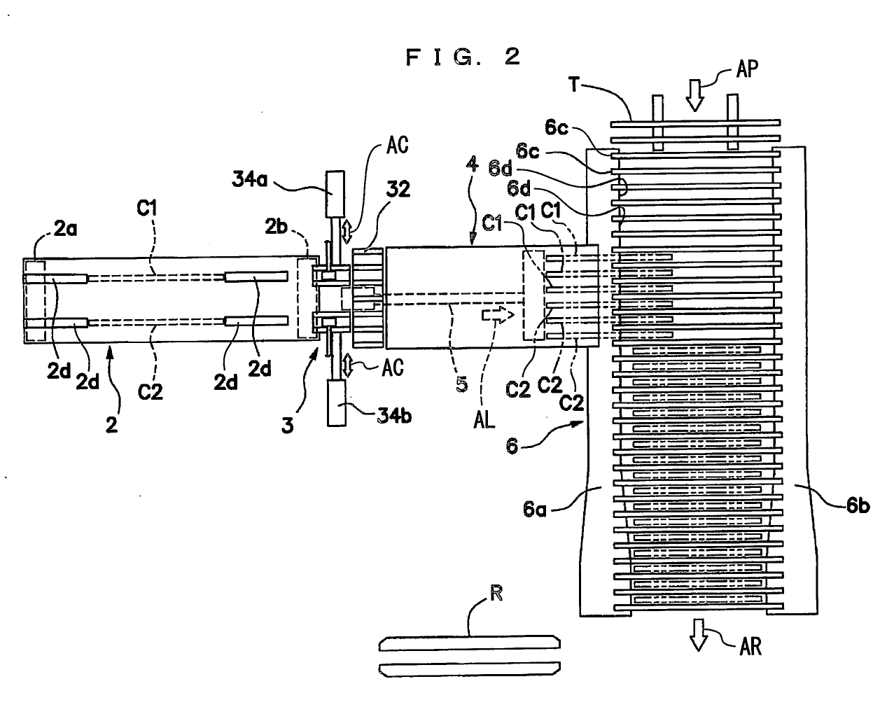

As shown in FIG. 1 and FIG. 2, the corrugated fin feeding apparatus of this embodiment has running cutting devices 1 which cut fin materials F to produce two lines of corrugated fins C1 and C2, a conveyor 2 which conveys the respective corrugated fins C1 and C2 produced by the running cutting devices 1, a forcible conveying device 3 which distributes the corrugated fin C1 and the corrugated fin C2, an accumulating case 4 which retains in predetermined positions the respective corrugated fins C1 and C2 conveyed from the forcible conveying device 3, an inserting device 5 which inserts the corrugated fins C1 and C2 retained in the accumulating case 4 into predetermined positions of a temporary assembling device 6 of a heat exchanger core, the temporary assembling device 6 of the heat exchanger core which temporary assembles the corrugated fins C1 and C2 with tubes, and a control device 8 which controls these devices.

Here, the conveyor 2 and the accumulating case 4 function as a conveying device of the present invention and an accumulating device of the present invention, respectively.

To the running cutting devices 1, two lines of the fin materials F in corrugated form which are divided into two on the upstream side thereof are fed continuously. The running cutting devices 1 is for cutting these fin materials F without stopping them to produce the corrugated fins C1 and C2 having a predetermined length. In this embodiment, two running cutting devices 1 are arranged in parallel to form the two lines of the corrugated fins C1 and C2.

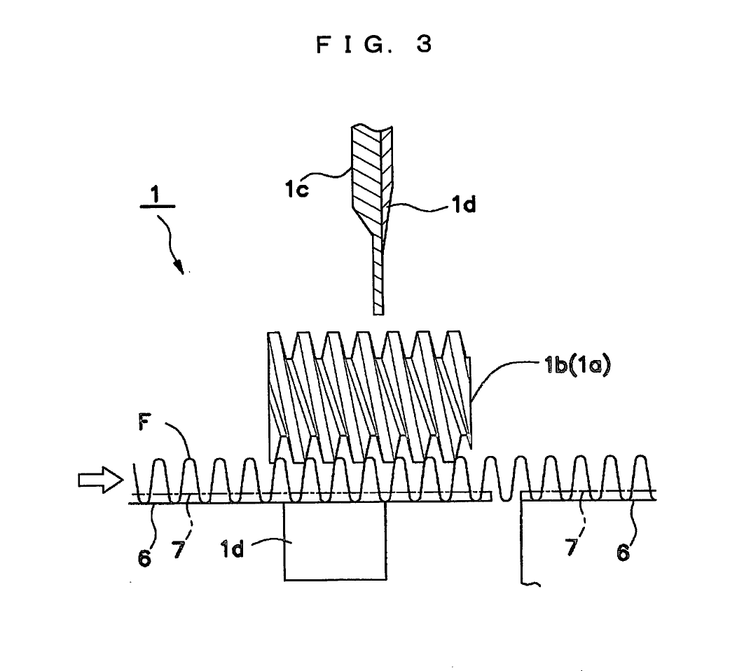

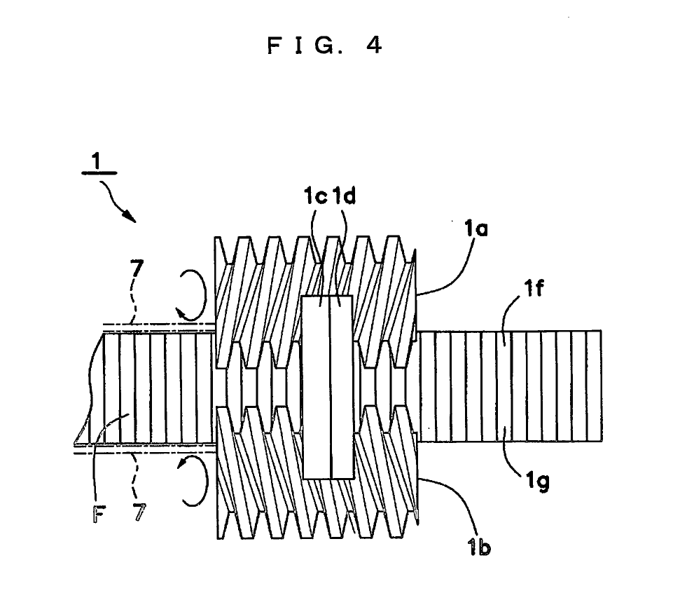

As shown in FIG. 3 and FIG. 4 in enlargement, each of the running cutting devices 1 has a pair of worms 1a and 1b, a guide piece 1c, and cutting blades 1d on both sides of the corrugated fins C1 and C2. Further, the running cutting devices 1 are provided with side walls 6 and fin guides 7 arranged on the top and bottom of the side walls 6 respectively so as to guide the fin materials F and the corrugated fins C1 and C2 being conveyed.

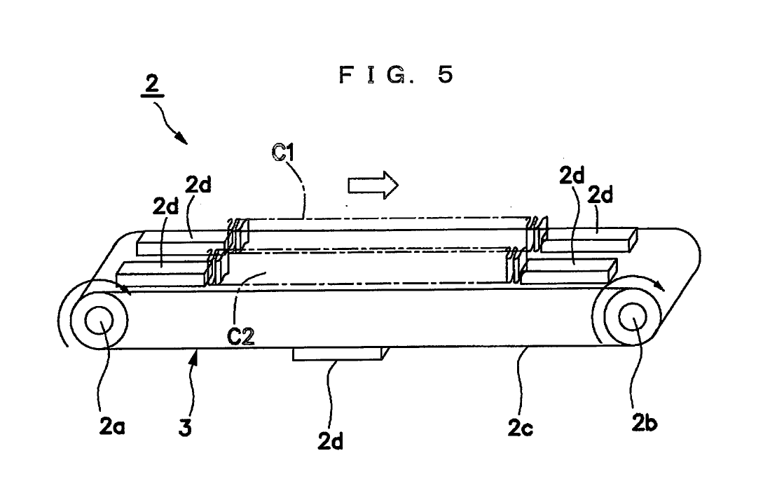

The conveyor 2 has, as shown in FIG. 5, a pair of conveying rollers 2a and 2b, a belt 2c provided around these conveying rollers 2a and 2b, and position restraining portions 2d provided on the belt 2c at predetermined intervals to be capable of holding the corrugated fins C1 and C2 therebetween.

The conveyor 2 is configured to arrange the corrugated fins C1 and C2 cut by the running cutting devices 1 between the position restraining portions 2d to determine their positions, to thereby convey them at predetermined intervals toward the downstream side thereof.

The moving speed of the belt 2c of the conveyor 2 is controlled by the control device 8 and set to be faster than the conveying speed of the corrugated fins C1 and C2 cut by the running cutting devices 1. For this purpose, the control device 8 detects positions of the corrugated fins C1 and C2 arranged between the position restraining portions 2d by the number of rotations of the conveying rollers 2a and 2b. Incidentally, the control device 8 synchronously controls the conveyor 2, the forcible conveying device 3, the accumulator case 4, and the inserting device 5 based on the positions of the corrugated fins determined by the conveying device.

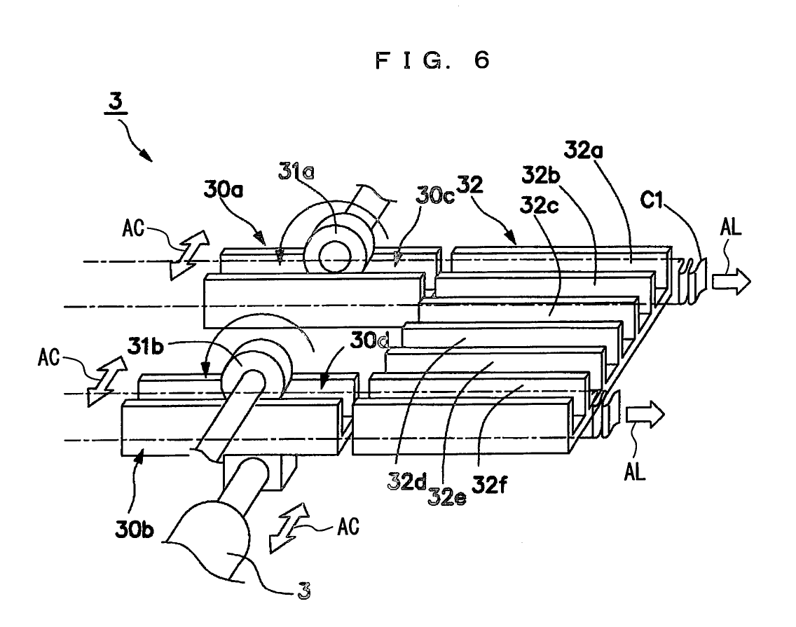

The forcible conveying device 3 is for distributing and feeding the corrugated fins C1 and C2 fed from the conveyor 2 into accumulating rooms of the accumulating case 4. The forcible conveying device 3 has, as shown in FIG. 6, distributing cases 30a and 30b and pushing out rollers 31a and 31b provided respectively for the corrugated fins C1 and C2, and a guide case 32.

On the distributing cases 30a and 30b, trenches 30c and 30d are formed respectively in a cross-sectional U shape which is open on the topside and on both end portions, and a bottom width of the U shape is formed to be substantially the same as the width of the corrugated fins C1 and C2.

Above the distributing cases 30a and 30b, there are arranged the pushing out rollers 31a and 31b for adding a driving force in a direction of arrows AL to upper portions of the corrugated fins C1 and C2 to push out the corrugated fins C1 and C2 toward the downstream side at a constant speed.

On the downstream side of the distributing cases 30a and 30b, six lines of guide trenches 32a to 32f, which are each open on the topside and on both end portions, are formed respectively, and a bottom width of these guide trenches 32a to 32f are formed to be substantially the same as the width of the trenches 30c and 30d of the distributing cases 30a and 30b.

The distributing case 30a and the pushing out roller 3 1a are, as shown in FIG. 2, movable in directions of arrows AC so that the trench 30c of the distributing case 30a corresponds to the guide trenches 32a to 32c of the guide case 32 by extending or contracting of a piston rod of a cylinder 34a in the directions of the arrows AC.

Specifically, corresponding to the corrugated fins C1 which are conveyed sequentially at predetermined intervals from the conveyor 2 to the distributing case 30a, the trench 30c of the distributing case 30a is connected in sequence to the guide trenches 32a, 32b, and 32c in their order. Then, by the pushing out roller 31a, the corrugated fin C1 is conveyed at a constant speed while the upper portion of the corrugated fin C1 is pushed toward the downstream side.

Similarly to the distributing case 30a and the pushing out roller 31a, the distributing case 30b and the pushing out roller 31b are provided to be movable so that the trench 30d of the distributing case 30b corresponds to the guide cases 32d to 32f by extending or contracting of a piston rod of a cylinder 34b in the directions of the arrows AC, and the corrugated fin C2 fed from the conveyor 2 is distributed to the guide trenches 32d to 32f and is conveyed at a constant speed while the upper portion of the corrugated fin C2 is pushed toward the downstream side.

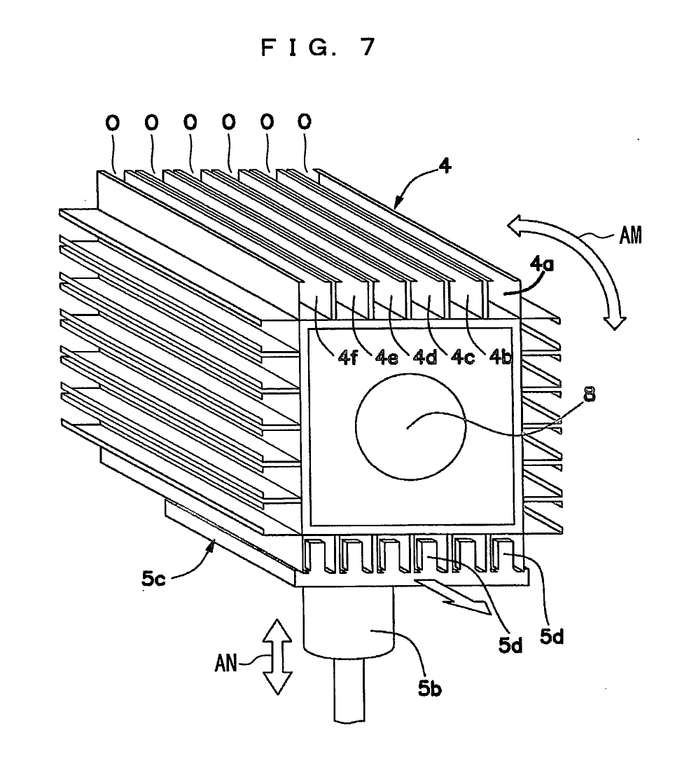

At an end portion of the guide case 32 on the downstream side, the accumulating case 4 is arranged in close proximity. The accumulating case 4 is, as shown in FIG. 7, formed in a rectangular shape having substantially the same length in a longitudinal direction as that of the corrugated fins C1 and C2, and a rotating shaft 8 is provided at the center portion therein.

Further, six accumulating rooms 4a to 4f, which are each open on the outside thereof and on both end portions and corresponding to the guide trenches 32a to 32f of the guide case 34, are provided respectively on four faces of the accumulating case 4.

The accumulating case 4 accommodates in order the corrugated fins C1 fed through the guide trenches 32a to 32c into the accumulating rooms 4a to 4c corresponding to the corrugated fin C1, and the accumulating case 4 similarly accommodates in order the corrugated fins C2 fed through the guide trenches 32d to 32f into the accumulating rooms 4d to 4f corresponding to the corrugated fin C2.

When six corrugated fins C are accommodated in the accumulating rooms 4a to 4f, a not-shown electric motor rotates the rotating shaft 8 in a circumferential direction denoted by an arrow AM by 90 degrees, so that the corrugated fins C1 and C2 can be accommodated in sequence in the respective accumulating rooms 4a to 4f on the four faces of the accumulating case 4.

The inserting device 5 has, as shown in FIG. 1 and FIG. 7, a cylinder 5a, a cylinder 5b fixed to the tip of a piston provided inside the cylinder Sa, and a pushing portion 5c which is fixed to the cylinder 5b and is capable of engaging with the accumulating rooms 4a to 4f of the accumulating case 4. The pushing portion 5c is capable of moving in a direction of an arrow AN by the cylinder 5b and is capable of engaging with and disengaging from the accumulating case 4.

Then, after the accumulating rooms 4a to 4f in which the corrugated fins C1 and C2 are accommodated rotates 180 degrees, in other words, rotates twice by 90 degrees to be positioned at the downside, the cylinder 5b is driven to insert tip portions 5d of the pushing portion 5c from rear end portions O of the outside opening portions of the accumulating rooms 4a to 4f and a piston rod is extended from the cylinder 5a toward the temporary assembling device 6 of the heat exchanger core, so that the tip portions 5d simultaneously feed the corrugated fins C1 and C2 accommodated in the accumulating rooms 4a to 4f to the temporary assembling device 6 of the heat exchanger core.

The temporary assembling device 6 of the heat exchanger core is for alternately arranging tubes and corrugated fins for a heat exchanger to temporarily assemble a heat exchanger core. The temporary assembling device 6 has a pair of sending shafts 6a and 6b. On these sending shafts 6a and 6b, tube guide trenches 6c which guide end portions of tubes T are formed, and between the adjacent tube guide trenches 6c, fin guide portions 6d which guide the end portions of the corrugated fins C1 and C2 are formed respectively in a spiral shape. The tubes T are sent in a direction of an arrow AP.

Incidentally, the spiral directions of the tube guide trenches 6c and the fin guide trenches 6d on both the sending shafts 6a and 6b are formed in reverse to each other so as to have a relationship of right-hand screw and left-hand screw, thereby rotating in directions reverse to each other.

A tube feeding portion, not shown, for feeding the tubes T is provided on the upstream side of both the sending shafts 6a and 6b. On the other hand, a reinforcement feeding portion, not shown, for feeding reinforcements R to be arranged on the top and bottom is provided on the downstream side of both the sending shafts 6a and 6b.

Hereinafter, operation of the corrugated fin feeding apparatus of the present invention will be described in order of manufacturing steps.

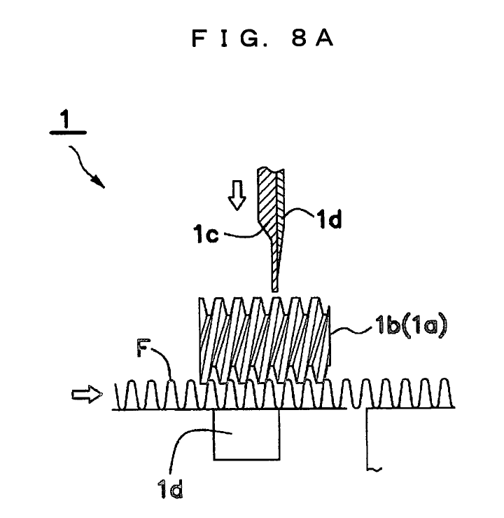

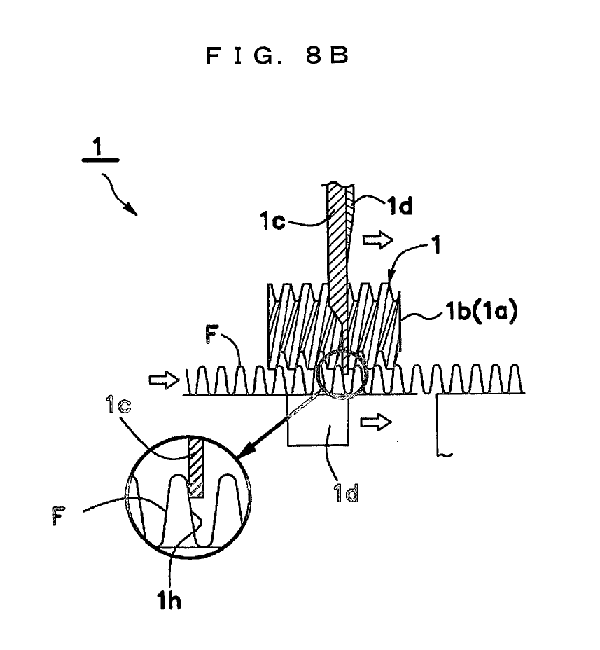

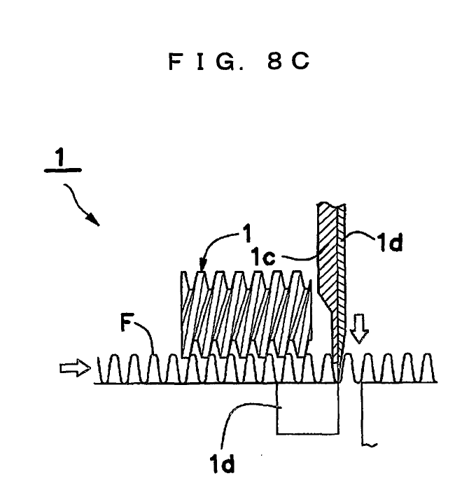

First, a cutting step will be described with the drawings of FIG. 8A to FIG. 8C.

Incidentally, in the corrugated fin feeding apparatus of this embodiment, the running cutting devices 1 are arranged corresponding to two lines of the corrugated fins C1 and C2 respectively and configured to operate in synchronization, but cutting of the corrugated fin C1 will be described in the following description.

The fin material F is fed to the running cutting device 1 and, as shown in FIG. 8A, the pair of worms 1a and 1b is rotated in directions reverse to each other to thereby move the fin material F toward the downstream side thereof, and the fin material F is conveyed toward the downstream side in sequence while counting the number of bottom portions of the fin material F in motion based on the number of rotations of the worms 1a and 1b.

Next, as shown in FIG. 8B, when the both worms 1a and 1b convey the fin material F by a predetermined number of the bottom portions, the guide piece 1c moves according to the conveyance of the fin material F and approaches a bottom portion 1h of the fin material F at a position engaging with the both worms 1a and 1b.

At this time, the both worms 1a and 1b engage with both shoulder portions of the fin material F to restrain the position of the bottom portion 1h of the fin material F, so that the guide piece 1c surely approaches the bottom portion 1h of the fin material F.

When determination of the position by the guide piece 1c is completed, the control device 8 resets the counting of the number of ridges of the worms 1a and 1b and starts new counting from a bottom portion that is one more upstream side from the bottom portion 1h.

On the other hand, the guide piece 1c which approached the bottom portion 1h of the fin material F moves toward the downstream side in synchronization with the fin material F, and with the guide piece 1c, upper and lower cutting blades 1d also move toward the downstream side.

Next, as shown in FIG. 8C, when the guide piece 1c passes the both worms 1a and 1b, the upper and lower cutting blades 1d moving with the fin material F are actuated to cut the bottom portion 1h along the guide piece 1c to thereby produce a corrugated fin C1 having a predetermined length.

Further, after the fin material F is cut, the guide piece 1 c and the cutting blades 1d return to their original positions and then wait until the fin material F is conveyed by the predetermined number of ridges again by the both worms 1a and 1b, so that the fin material F can be cut without stopping the conveyance. Incidentally, although the description of cutting the corrugated fin C2 is omitted, a corrugated fin C2, having a predetermined length, is produced similarly to the case of the above described corrugated fin C1.

In a subsequent conveying step, the corrugated fins C1 and C2 cut by a predetermined length by the running cutting devices 1 fall downward and are conveyed in sequence at predetermined intervals toward the downstream side in a state being arranged between the position restraining portions 2d of the conveyor 2.

At this time, although the corrugated fins C1 and C2 are cut by a predetermined length, they are scarcely separated and in a state being lined up continuously.

Accordingly, as described above, the moving speed of the belt 2c of the conveyor 2 is set faster than the conveying speed of the corrugated fins C1 and C2 cut by the running cutting devices 1 so as to add a force to increase the speed of the corrugated fins C1 and C2 in the conveying direction when they fall downward, so that the corrugated fins C1 and C2 are separated by this speed-increasing force.

Further, the corrugated fins are also separated at least by gravitational acceleration of the rear end portions of the corrugated fins falling down to the conveyor 2.

Next, in a forcible conveying step, the forcible conveying device 3 distributes the corrugated fins C1 conveyed in sequence from the conveyor 2 into the guide trenches 32a to 32c by the distributing case 30a and push them out respectively by the pushing out roller 31a toward the downstream side.

Further, similarly to the distributing case 30a, the distributing case 30b also distributes the corrugated fins C2 conveyed in sequence into the guide cases 32d to 32f and push them out by the pushing out roller 31b toward the downstream side.

Next, in an accumulating step, the accumulating case 4 accommodates in sequence the corrugated fins C1 and C2 fed from the guide cases 32a to 32f into the accumulating rooms 4a to 4f of the accumulating case 4.

Then, when a total of six of the corrugated fins C1 and C2 are accommodated into the accumulating rooms 4a to 4f, the corrugated fins C1 and C2 are accommodated in sequence into accumulating rooms 4a to 4f on another face of the accumulating case 4 while rotating the accumulating case 4 by 90 degrees in a circumferential direction of the center axis 8.

Next, the process proceeds to an inserting step. When the accumulating rooms 4a to 4f which accommodated the corrugated fins C1 and C2 in the accumulating step are positioned at the downside, the inserting device 5 is actuated to feed the total of six of the corrugated fins C1 and C2 accommodated in the accumulating rooms 4a to 4f simultaneously into the corresponding fin guide portions 6d of the temporary assembling device 6 of the heat exchanger core from the side thereof.

Thus, the corrugated fins C1 and C2 fed to the temporary assembling device 6 of the heat exchanger core are moved with the tubes T in the tube guide trenches 6c and the fin guide portions 6d by the rotation of the sending shafts 6a and 6b, and the spaces between them are narrowed similarly to the case of a conventional temporary assembling device of a heat exchanger core so that the tubes T and the corrugated fins C1 and C2 comes in contact with each other on the downstream side, thereby temporarily assembling the heat exchanger core at the reinforcement feeding portion.

By the position restraining portions 2d of the conveyor, positions of the corrugated fins C1 and C2 being conveyed are controlled by the control device 8 at all times, and the operation of the forcible conveying device 3, the accumulating case 4, and the inserting device 5 are synchronously controlled by the control device 8 based on the positions of the corrugated fins C1 and C2.

Therefore, according to the corrugated fin feeding apparatus of this embodiment, the following advantages can be achieved.

Specifically, according to this corrugated fin feeding apparatus, the running cutting devices 1 cut the fin materials F without stopping the conveyance thereof, which increases the speed of production compared to the conventional devices, to thereby produce corrugated fins having a predetermined length.

Further, the control device 8 detects positions of the corrugated fins C1 and C2 being conveyed by the conveyor 2 to synchronously control the operation of the forcible conveying device 3, the accumulating case 4, and the inserting device 5 on the downstream side, so that the operation of temporarily assembling the corrugated fins C1 and C2 after being cut can be surely and easily controlled.

Further, in the corrugated fin feeding apparatus of this embodiment, the corrugated fins C1 and C2 are formed in multiple lines to be distributed by the forcible conveying device 3 in three directions, the accumulating case 4 is rotated, and a total of six of the corrugated fins C1 and C2 are accommodated to be fed to the assembling device 6 of the heat exchanger core, so that a plurality of the corrugated fins can be fed to the assembling device 6 of the heat exchanger core in a shorter time with lower cost as compared to conventional devices, thereby contributing to increase productivity of the heat exchanger core.

In the foregoing, the corrugated fin feeding apparatus of the embodiment according to the present invention has been described, but the specific structure of the present invention is not limited to this embodiment. The present invention includes any change of design in the range not departing from the gist of the invention.

For example, for the corrugated fin feeding apparatus of this embodiment, an example of manufacturing the corrugated fins of two lines by dividing a fin material into two on the upstream side of the running cutting devices 1 is described, but the present invention may be applied to one formation of corrugated fin or multiple formation of corrugated fins of more than two lines.

### INDUSTRIAL APPLICABILITY

The corrugated fin feeding apparatus and the corrugated fin feeding method of the present invention can be applied to a case of feeding corrugated fins to a temporary assembling device of a heat exchanger core which temporarily assembles a core of a heat exchanger during manufacturing of the heat exchanger, which has tubes and corrugated fins arranged alternately and is used for an automobile or the like.

1. A corrugated fin feeding apparatus for feeding corrugated fins to a temporary assembling device of a heat exchanger core which alternately arranges tubes and corrugated fins for a heat exchanger to temporarily assemble the heat exchanger core, the corrugated fin feeding apparatus comprising:
a cutting device which cuts a continuous fin material in corrugated form without stopping conveyance of the fin material toward a downstream side thereof to thereby produce corrugated fins having a predetermined length; and
a conveying device which adds a force to the corrugated fins being cut to increase a speed thereof to separate the adjacent corrugated fins from each other to thereby convey the corrugated fins at predetermined intervals.

2. The corrugated fin feeding apparatus according to claim 1 further comprising:
a forcible conveying device which adds a driving force to the corrugated fins being conveyed to push out the corrugated fins toward a downstream side thereof and distributes the corrugated fins in predetermined directions;
an accumulating device having a plurality of accumulating rooms into which the corrugated fins are distributed and accommodated respectively;
an inserting device which feeds a predetermined number of the corrugated fins simultaneously to the temporary assembling device of the heat exchanger core when the predetermined number of the corrugated fins are accommodated into the accumulating rooms; and
a control device which synchronously controls said forcible conveying device, said accumulating device, and said inserting device based on positions of the corrugated fins determined by said conveying device.

3. The corrugated fin feeding apparatus according to claim 1,
wherein said conveying device comprises:
a belt conveyor which has a belt to convey the corrugated fins; and
position determining portions provided at predetermined intervals on the belt of said belt conveyor,
wherein the corrugated fins are arranged between said position determining portions to determine positions of the corrugated fins to thereby convey the corrugated fins at predetermined intervals.

4. The corrugated fin feeding apparatus according to claim 1,
wherein said accumulating device comprises:
a rotating shaft; and
a plurality of said accumulating rooms provided in parallel to an axial direction of said rotating shaft,
wherein the corrugated fins are accommodated while said plural accumulating rooms are rotated in a circumferential direction of said rotating shaft, and said inserting device feeds after the rotation thereof the corrugated fins to the temporary assembling device of the heat exchanger core.

5. A corrugated fin feeding method for feeding corrugated fins to a temporary assembling device of a heat exchanger core which alternately arranges tubes and corrugated fins to temporarily assemble the heat exchanger core, the corrugated fin feeding method comprising:
a cutting step of cutting a continuous fin material in corrugated form without stopping conveyance of the fin material toward a conveying direction thereof to thereby produce corrugated fins having a predetermined length; and
a conveying step of adding a force to the corrugated fins being cut to increase a speed thereof to separate the adjacent corrugated fins from each other, determining front and rear positions of the corrugated fins, and conveying the corrugated fins.

6. The corrugated fin feeding method according to claim 5, further comprising:
a forcibly conveying step of adding a driving force to the corrugated fins being conveyed to push out the corrugated fins toward a downstream side thereof and distributing the corrugated fins in predetermined directions;
an accumulating step of accommodating the corrugated fins being distributed into a plurality of accumulating rooms; and
an inserting step of feeding the corrugated fins to the temporary assembling device of the heat exchanger core when a predetermined number of the corrugated fins is accumulated into the accumulating rooms.

7. The corrugated fin feeding apparatus according to claim 2,
wherein said conveying device comprises:
a belt conveyor which has a belt to convey the corrugated fins; and
position determining portions provided at predetermined intervals on the belt of said belt conveyor,
wherein the corrugated fins are arranged between said position determining portions to determine positions of the corrugated fins to thereby convey the corrugated fins at predetermined intervals.

8. The corrugated fin feeding apparatus according to claim 2,
wherein said accumulating device comprises:
a rotating shaft; and
a plurality of said accumulating rooms provided in parallel to an axial direction of said rotating shaft,
wherein the corrugated fins are accommodated while said plural accumulating rooms are rotated in a circumferential direction of said rotating shaft, and said inserting device feeds after the rotation thereof the corrugated fins to the temporary assembling device of the heat exchanger core.

9. The corrugated fin feeding apparatus according to claim 3,
wherein said accumulating device comprises:
a rotating shaft; and
a plurality of said accumulating rooms provided in parallel to an axial direction of said rotating shaft,
wherein the corrugated fins are accommodated while said plural accumulating rooms are rotated in a circumferential direction of said rotating shaft, and said inserting device feeds after the rotation thereof the corrugated fins to the temporary assembling device of the heat exchanger core.
